(19) United States
(12) Patent Application Publication
(10) Pub. No.: US 2022/0018580 A1
(43) Pub. Date: Jan. 20, 2022

(54) HEAT PUMP

(71) Applicant: LG ELECTRONICS INC., Seoul (KR)

(72) Inventors: Minsoo KIM, Seoul (KR); Eunjun CHO, Seoul (KR); Pilhyun YOON, Seoul (KR); Jihyeong RYU, Seoul (KR); Youngmin LEE, Seoul (KR); Hojin SEO, Seoul (KR)

(21) Appl. No.: 17/356,951

(22) Filed: Jun. 24, 2021

(30) Foreign Application Priority Data
Jul. 20, 2020 (KR) 10-2020-0089520

(51) Int. Cl. F25B 30/02; F25B 49/02

(52) U.S. Cl. CPC F25B 30/02; F25B 49/022; F25B 2600/11; F25B 2313/0294; F25B 2600/021

(57) ABSTRACT

A heat pump is provided that may include an indoor unit including an indoor heat exchanger; an outdoor unit including an outdoor heat exchanger and a compressor that compresses a refrigerant; a housing that forms an outer shape of the outdoor unit and provides an internal space in which the outdoor heat exchanger and the compressor are disposed; a partition wall that is disposed in the internal space of the housing, and divides the internal space into a flow path space in which the outdoor heat exchanger is disposed and a cycle space in which the compressor is disposed; an outdoor fan disposed in the flow path space to cause an air flow; and a controller that controls an operation of the compressor and the outdoor fan. The housing may include a hole that communicates with the cycle space, and the partition wall may include a barrier hole that communicates the flow path space and the cycle space.

### CROSS-REFERENCE TO RELATED APPLICATION(S)

This application claims the priority benefit of Korean Patent Application No. 10-2020-0089520, filed in Korea on Jul. 20, 2020, the disclosure of which is incorporated herein by reference in its entirety.

### BACKGROUND

### 1. Field

A heat pump is disclosed herein.

### 2. Background

In general, a heat pump refers to a device that cools and heats a room through processes of compression, condensation, expansion, and evaporation of a refrigerant. When an outdoor heat exchanger of the heat pump serves as a condenser, whereas an indoor heat exchanger serves as an evaporator, the room can be cooled. On the other hand, when the outdoor heat exchanger of the heat pump serves as an evaporator, whereas the indoor heat exchanger serves as a condenser, the room can be heated.

The refrigerant circulating through such a heat pump may be provided as a flammable refrigerant. In this case, when a flammable refrigerant leaks from the refrigerant pipe, the refrigerant may be ignited by a spark generated in an electric device, such as an inverter board, so that a fire, for example, may occur. Accordingly, a lot of research has been conducted on a structure for discharging the refrigerant leaked from the refrigerant pipe to the outside.

### BRIEF DESCRIPTION OF THE DRAWINGS

Embodiments will be described in detail with reference to the following drawings in which like reference numerals refer to like elements, and wherein:

FIG. 1A is a schematic diagram of a heat pump capable of switching between a heating operation and a cooling operation and a flow of a refrigerant according to an embodiment;

FIG. 1B is a control diagram of a heat pump according to an embodiment;

FIG. 2 is a schematic diagram illustrating an internal configuration of an outdoor unit according to an embodiment, and illustrating a flow path part and a cycle part disposed at left and right sides across a partition wall in which a barrier hole is formed;

FIGS. 3A-3B are schematic diagrams for explaining a damper installed in a partition wall to open or close a barrier hole according to an embodiment;

FIG. 4 is a flow chart illustrating a control procedure of a heat pump according to an embodiment;

FIG. 5 is a flow chart illustrating a control procedure of a heat pump according to another embodiment; and

FIGS. 6 and 7 are graphs for explaining a change in a leakage refrigerant concentration according to ventilation time.

### DETAILED DESCRIPTION

Description will now be given according to exemplary embodiments disclosed herein, with reference to the accompanying drawings. For the sake of brief description with reference to the drawings, the same or equivalent components may be denoted by the same reference numbers, and description thereof will not be repeated. In general, suffixes such as “module” and “unit” may be used to refer to elements or components. Use of such suffixes herein is merely intended to facilitate description of the specification, and the suffixes do not have any special meaning or function. In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, embodiments should be construed to extend to any alterations, equivalents, and substitutes in addition to those which are particularly set out in the accompanying drawings.

It will be understood that although the terms first, second, etc. may be used herein to describe various elements, these elements should not be limited by these terms. These terms are only used to distinguish one element from another. It will be understood that when an element is referred to as being “connected with” another element, there may be intervening elements present. In contrast, it will be understood that when an element is referred to as being “directly connected with” another element, there are no intervening elements present. A singular representation may include a plural representation unless context clearly indicates otherwise. Terms such as “includes” or “has” used herein should be considered as indicating the presence of several components, functions or steps, disclosed in the specification, and it is also understood that more or fewer components, functions, or steps may likewise be utilized.

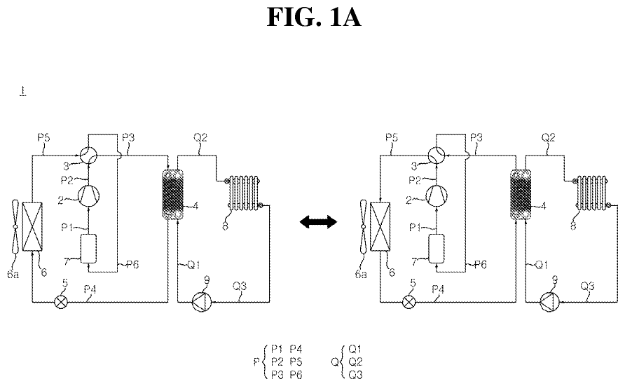

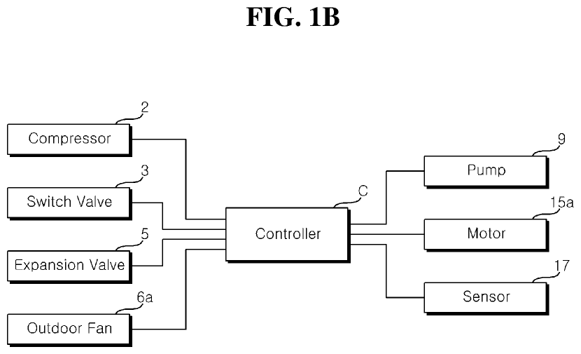

Referring to FIG. 1A, a heat pump 1 may include a compressor 2, a switching valve 3, a heat exchanger 4, an outdoor heat exchanger 6, an expansion valve 5, and an accumulator 7. The compressor 2 may compress the refrigerant that flows from the accumulator 7 and discharge a high-temperature and high-pressure refrigerant. In this case, the accumulator 7 may provide a vapor refrigerant to the compressor 2 through a first pipe P1. A second pipe P2 may be installed between the compressor 2 and the switching valve 3 to provide a flow path of refrigerant from the compressor 2 to the switching valve 3.

The switching valve 3 may receive the refrigerant which is discharged from the compressor 2 and passes through the second pipe P2. In addition, the switching valve 3 may selectively guide the refrigerant that flows through the second pipe P2 to the heat exchanger 4 or the outdoor heat exchanger 6, by switching the flow path according to an operation mode of the heat pump 1. For example, the switching valve 3 may be a four-way valve. A sixth pipe P6 may be installed between the switching valve 3 and the accumulator 7 to provide a flow path of refrigerant from the switching valve 3 to the accumulator 7.

For example, when the heat pump 1 performs a heating operation, the switching valve 3 may guide the refrigerant flowing through the second pipe P2 to the heat exchanger 4. In this case, the heat exchanger 4 may serve as a condenser, and the outdoor heat exchanger 6 may serve as an evaporator. For another example, when the heat pump 1 performs a cooling operation, the switching valve 3 may guide the refrigerant flowing through the second pipe P2 to the outdoor heat exchanger 6. In this case, the outdoor heat exchanger 6 may serve as a condenser, and the heat exchanger 4 may serve as an evaporator.

The outdoor heat exchanger 6 may exchange heat between a refrigerant and a heat transfer medium. A heat transfer direction between the refrigerant and the heat transfer medium in the outdoor heat exchanger 6 may differ depending on the operation mode of the heat pump 1, that is, depending on whether it is a heating operation or a cooling operation.

For example, the heat transfer medium may be outdoor air, and heat exchange may be performed between the refrigerant and outdoor air in the outdoor heat exchanger 6. In this case, an outdoor fan 6a may be disposed in or at one side of the outdoor heat exchanger 6 to control an amount of air provided to the outdoor heat exchanger 6. A fifth pipe P5 may be installed between the switching valve 3 and the outdoor heat exchanger 6 to provide a flow path for refrigerant between the switching valve 3 and the outdoor heat exchanger 6.

The heat exchanger 4 may exchange heat between the refrigerant and the heat transfer medium. A heat transfer direction between the refrigerant and the heat transfer medium in the heat exchanger 4 may differ depending on the operation mode of the heat pump 1, that is, depending on whether it is a heating operation or a cooling operation. A third pipe P3 may be installed between the switching valve 3 and the heat exchanger 4 to provide a flow path for refrigerant between the switching valve 3 and the heat exchanger 4.

For example, the heat transfer medium may be indoor air, and heat exchange may be performed between the refrigerant and the indoor air in the heat exchanger 4. In this case, an indoor fan (not shown) may be disposed in or at one side of the heat exchanger 4 to control the amount of air provided to the heat exchanger 4.

For another example, the heat transfer medium may be water, and heat exchange may be performed between the refrigerant and water in the heat exchanger 4. In this case, the water that passes through the heat exchanger 4 may be supplied to a radiator 8 installed indoors or a pipe installed in a floor to cool or heat an indoor space, or used to supply hot or cold water to a room by heating or cooling water stored in a hot water tank. The heat pump 1 may be referred to as an “air-to-water heat pump” (AWHP). The radiator 8 may be referred to as an “indoor heat exchanger”.

The heat pump 1 may include a pump 9 and radiator 8. When the pump 9 is driven, water may circulate through a water pipe Q. The radiator 8 may be installed indoors, and receive water that is heated or cooled while flowing through the heat exchanger 4. For example, the heated water may pass through the radiator 8 and may radiate heat to the surroundings, thereby heating the indoor space. For example, the cooled water may pass through the radiator 8 and may absorb heat from the surroundings, thereby cooling the indoor space. The heat pump 1 may replace the radiator 8 with an indoor heat transfer unit or, along with it, may have a water pipe or a fan coil unit (FCU) installed in the indoor floor.

A first water pipe Q1 may be installed between the pump 9 and the heat exchanger 4 to provide a water flow path between the pump 9 and the heat exchanger 4. In addition, a second water pipe Q2 may be installed between the heat exchanger 4 and the radiator 8 to provide a water flow path between the heat exchanger 4 and the radiator 8. In addition, a third water pipe Q3 may be installed between the radiator 8 and the pump 9 to provide a water flow path between the radiator 8 and the pump 9.

The expansion valve 5 may be installed in a fourth pipe P4 to expand the refrigerant flowing through the flow path of the fourth pipe P4. The fourth pipe P4 may be installed between the heat exchanger 4 and the outdoor heat exchanger 6 to provide a flow path for refrigerant connecting the heat exchanger 4 and the outdoor heat exchanger 6. For example, the expansion valve 5 may be an electronic expansion valve (EEV).

A controller C (see FIG. 1B) may control operation of the heat pump 1. The controller C may be electrically connected to each component of the heat pump 1, as shown in FIG. 1B. The controller C may adjust operation of each component of the heat pump 1 according to the operation mode of the heat pump 1.

Hereinafter, the heat pump 1 is described as an example of an AWHP; however, embodiments are not limited thereto.

Referring to the left drawing of FIG. 1A, a case in which the heat pump 1 performs a heating operation will be described as follows.

When a heating operation signal is received by the heat pump 1, the controller C adjusts the flow path of the switching valve 3 so that the refrigerant discharged from the compressor 2 is guided to the heat exchanger 4, and controls an opening degree of the flow path of the fourth pipe P4 by the expansion valve 5. Next, the controller C may drive the compressor 2 to circulate refrigerant in refrigerant pipe P, and drive the pump 9 to circulate water in water pipe Q.

For example, a heating operation signal may be a signal arbitrarily input by a user. For another example, the heating operation signal may be a signal provided to the controller C by a thermostat provided in an indoor space, when an indoor temperature detected by an indoor temperature sensor is lower than a desired temperature set by the user by a certain or predetermined level or more.

More specifically, low-temperature and low-pressure refrigerant flowing from the accumulator 7 to the compressor 2 through the first pipe P1 may be compressed in the compressor 2 and discharged in a high-temperature and high-pressure state. The refrigerant discharged from the compressor 2 may flow into the heat exchanger 4 through the second pipe P2, the switching valve 3, and the third pipe P3, sequentially.

As heat energy is transferred from the refrigerant to water in the heat exchanger 4, the refrigerant may be condensed. At this time, the heat exchanger 4 may serve as a condenser. In addition, according to heat exchange between the refrigerant and water, a temperature of the water flowing into the heat exchanger 4 from the pump 9 through the first water pipe Q1 may increase. Water which is heated while passing through the heat exchanger 4 may flow into the radiator 8 through the second water pipe Q2 to heat the indoor space. The water whose temperature has decreased while passing through the radiator 8 may be returned to the pump 9 through the third water pipe Q3.

For example, the heat exchanger 4 may be a plate heat exchanger including a plurality of heat transfer plates stacked on each other. In this case, the refrigerant and water may exchange heat with each other in a non-contact manner by flowing through a flow path formed between the plurality of heat transfer plates. For another example, the heat exchanger 4 may be a water tank in which a port through which water is introduced or discharged is formed. In this case, a pipe through which the refrigerant flows may be provided in the form of a coil along an outer circumferential surface of the water tank, so that refrigerant and water may exchange heat with each other in a non-contact manner.

The refrigerant condensed while passing through the heat exchanger 4 may pass through the expansion valve 5 in the fourth pipe P4 and may be expanded in a low temperature and low pressure state. At this time, the expansion valve 5 may control a suction superheat degree by adjusting an opening degree of the flow path of the fourth pipe P4. The suction superheat degree may be defined as a difference between a temperature of the refrigerant suctioned into the compressor 2 and a saturation temperature of the refrigerant evaporated in the outdoor heat exchanger 6. In addition, the refrigerant passing through the expansion valve 5 may flow into the outdoor heat exchanger 6.

As the heat energy of outdoor air is transferred from the outdoor heat exchanger 6 to the refrigerant, the refrigerant may be evaporated. At this time, the outdoor heat exchanger 6 may serve as an evaporator. The refrigerant which is evaporated while passing through the outdoor heat exchanger 6 may flow into the accumulator 7 through the fifth pipe P5, the switching valve 3, and the sixth pipe P6, sequentially, so that a cycle for the above-described heating operation of heat pump may be completed.

Referring to the drawing on the right of FIG. 1A, a case in which the heat pump 1 performs a cooling operation will be described as follows.

When a cooling operation signal is received by the heat pump 1, the controller C may adjust the flow path of the switching valve 3 so that the refrigerant discharged from the compressor 2 is guided to the outdoor heat exchanger 6, and may control the opening degree of the flow path of the fourth pipe P4 by the expansion valve 5. Next, the controller C may drive the compressor 2 to circulate the refrigerant in the refrigerant pipe P, and drive the pump 9 to circulate water in the water pipe Q.

For example, the cooling operation signal may be a signal arbitrarily input by a user. For another example, the cooling operation signal may be a signal provided to the controller C by the thermostat provided in the indoor space, when the indoor temperature detected by the indoor temperature sensor is higher than a desired temperature set by the user by a certain or predetermined level or more.

More specifically, the low-temperature and low-pressure refrigerant flowing from the accumulator 7 to the compressor 2 through the first pipe P1 may be compressed in the compressor 2 and discharged in a high-temperature and high-pressure state. The refrigerant discharged from the compressor 2 may flow into the outdoor heat exchanger 6 through the second pipe P2, the switching valve 3, and the fifth pipe P5 sequentially.

As heat energy is transferred from the refrigerant to the outdoor air in the outdoor heat exchanger 6, the refrigerant may be condensed. At this time, the outdoor heat exchanger 6 may serve as a condenser. The refrigerant which is condensed while passing through the outdoor heat exchanger 6 may pass through the expansion valve 5 in the fourth pipe P4 and may be expanded to a low temperature and low pressure state. At this time, the expansion valve 5 may control the suction superheat degree by adjusting the opening degree of the flow path of the fourth pipe P4. The suction superheat degree may be defined as a difference between the temperature of the refrigerant suctioned into the compressor 2 and the saturation temperature of the refrigerant evaporated in the heat exchanger 4. In addition, the refrigerant passing through the expansion valve 5 may flow into the heat exchanger 4.

As the heat energy of water is transferred from the heat exchanger 4 to the refrigerant, the refrigerant may be evaporated. At this time, the heat exchanger 4 may serve as an evaporator. In addition, according to the heat exchange between the refrigerant and water, the temperature of the water flowing from the pump 9 to the heat exchanger 4 through the first water pipe Q1 may decrease. Water which is cooled while passing through the heat exchanger 4 may flow into the radiator 8 through the second water pipe Q2 to cool the indoor space. Water which has passed through the radiator 8 and has an increased temperature may be returned to the pump 9 through the third water pipe Q3.

For example, the heat exchanger 4 may be a plate heat exchanger including a plurality of heat transfer plates stacked on each other. In this case, the refrigerant and water may exchange heat with each other in a non-contact manner of flowing through a flow path formed between the plurality of heat transfer plates. For another example, the heat exchanger 4 may be a water tank in which a port through which water is introduced or discharged is formed. In this case, a pipe through which the refrigerant flows may be provided in the form of a coil along an outer circumferential surface of the water tank, so that refrigerant and water may exchange heat with each other in a non-contact manner.

The refrigerant which is evaporated while passing through the heat exchanger 4 may flow into the accumulator 7 through the third pipe P3, the switching valve 3, and the sixth pipe P6, sequentially, so that a cycle for the above-described cooling operation of heat pump can be completed.

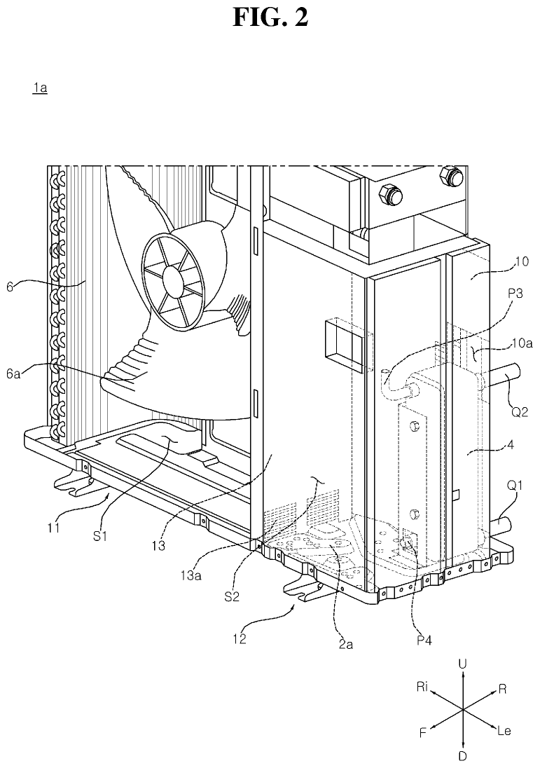

Referring to FIGS. 1A and 2, the heat pump 1 may include an outdoor unit 1a and an indoor unit 1b.

The outdoor unit 1a may include the accumulator 7, the compressor 2, the switching valve 3, the heat exchanger 4, the expansion valve 5, the outdoor heat exchanger 6, and the outdoor fan 6a described above. The indoor unit 1b may include the above described radiator 8. The radiator 8 may be referred to as an “indoor heat exchanger”. The pump 9 may be provided in the indoor unit 1b or in the outdoor unit 1a, or may be separately provided between the indoor unit 1b and the outdoor unit 1a.

In addition, the outdoor unit 1a may include a housing 10 and a partition wall 13. The housing 10 may form an outer shape of the outdoor unit 1a. The housing 10 may provide an internal accommodation space in which the above-described accumulator 7, compressor 2, switching valve 3, heat exchanger 4, expansion valve 5, outdoor heat exchanger 6, and outdoor fan 6a may be installed. The partition wall 13 may extend lengthwise in a vertical direction UD, and may be formed in a plate shape as a whole. The partition wall 13 may be installed in an internal accommodation space of the housing 10 to divide the internal accommodation space of the housing 10 into a flow path space S1 and a cycle space S2. The partition wall 13 may be referred to as a “barrier”.

For example, a flow path part or portion 11 of the outdoor unit 1a may be located at or in a rightward direction Ri of the partition wall 13 and may include the flow path space S1. For example, a cycle part or portion 12 of the outdoor unit 1a may be located at or in a leftward direction Le of the partition wall 13 and may include the cycle space S2. The cycle part 12 may be referred to as a “machine room” or a “machine unit”.

The flow path part 11 may be provided with the outdoor heat exchanger 6 and the outdoor fan 6a. In this case, an inflow hole (not shown) through which outdoor air may flow in and a discharge hole (not shown) through which outdoor air may be discharged may be formed in the housing 10 surrounding an outside of the flow path part 11. Accordingly, when the outdoor fan 6a is driven, the outdoor air that flows in through the inflow hole may perform heat exchange with the outdoor heat exchanger 6, and then may be discharged to the outside through the discharge hole. That is, the inflow hole may provide outdoor air to the outdoor fan 6a, and the discharge hole may discharge the air that passed through the outdoor fan 6a to the outside. In this case, the inflow hole and the discharge hole may be formed in a part or portion of the housing 12 forming a boundary of the flow path space S1. For example, the outdoor heat exchanger 6 may be installed in or at a right inner surface and a rear inner surface of the flow path part 11. For example, the outdoor fan 6a may be installed in or at a center of the flow path part 11.

The cycle part 12 may be provided with the accumulator 7, the compressor 2, the switching valve 3, the heat exchanger 4, and the expansion valve 5. For example, the accumulator 7, the compressor 2, and the heat exchanger 4 may be fixed in a mount 2a provided below the cycle part 12. In addition, an inverter board (not shown) that controls a frequency of the compressor 2, for example, may also be fixed in the mount 2a.

For example, the heat exchanger 4 may be a water-refrigerant heat exchanger, and may be a plate heat exchanger including a plurality of heat transfer plates stacked on each other. In this case, the first water pipe Q1 and the second water pipe Q2 may be connected to the heat exchanger 4 in or at a rear side of the heat exchanger 4, and the third pipe P3 and the fourth pipe P4 may be connected to the heat exchanger 4 in or at a front side of the heat exchanger 4.

A barrier hole 13a may be formed in or at one side of the partition wall 13. The barrier hole 13a may penetrate the partition wall 13 in a left-right or lateral direction LR. In this case, the flow path space S1 and the cycle space S2 may communicate with each other through the barrier hole 13a. In addition, a hole 10a through which air may be introduced may be formed in the housing 10 surrounding the outer side of the cycle part 12. The hole 10a may be formed in a part or portion of the housing 10 forming the boundary of the cycle space S2. For example, the hole 10a may be provided in or at a rear side surface of the housing 10, and the above-described second water pipe Q2 may pass through the hole 10a.

In this case, when the outdoor fan 6a is driven, outdoor air introduced through the hole 10a may flow into the flow path 11 through the barrier hole 13a, and may be discharged to the outside through the discharge hole. Thus, even if the refrigerant leaks from the refrigerant pipe P installed in the cycle part 12, the leaked refrigerant may be discharged to the outside together with outdoor air by the flow of air, which flows from the hole 10a to the discharge hole through the barrier hole 13a, generated by the outdoor fan 6a. Accordingly, it is possible to prevent a risk, such as a fire, due to ignition of the flammable refrigerant leaked from the refrigerant pipe P installed in the cycle part 12.

For example, the refrigerant flowing through the refrigerant pipe P may be a flammable refrigerant and may have a density greater than that of air. In this case, the barrier hole 13a may be provided adjacent to the lower end of the partition wall 13. For example, the barrier hole 13a may include a plurality of barrier holes 13a spaced apart from each other in a frontward-rearward direction FR and the vertical direction UD. Further, considering that the density of air is less than that of the flammable refrigerant, the hole 10a may be located above the barrier hole 13a. For example, the barrier hole 13a may be provided adjacent to the upper end of the rear surface of the housing 10.

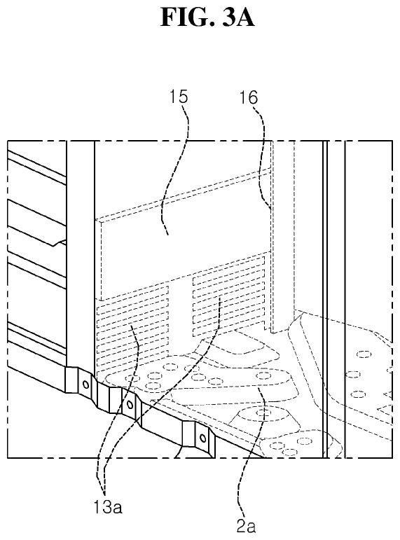

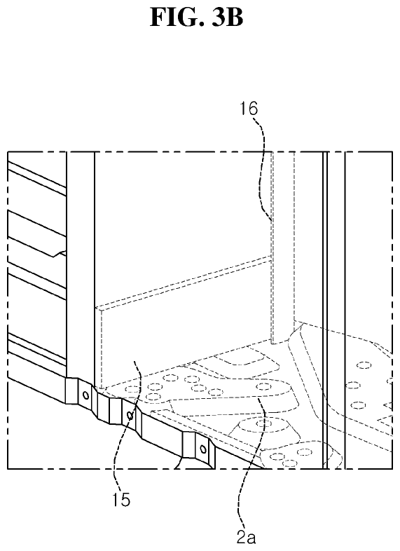

Referring to FIGS. 3A-3B, the outdoor unit 1a (see FIG. 2) may include a damper 15 and a guide rail 16. The damper 15 may be installed in or at one side of the partition wall 13. For example, the damper 15 may be installed in or at a left side surface of the partition wall 13 to be movable in the vertical direction UD.

Referring to FIG. 3A, the damper 15 may be located above the barrier hole 13a. In this case, the flow path space S1 and the cycle space S2 may communicate with each other through the barrier hole 13a.

Referring to FIG. 3B, the damper 15 may be moved from an upper side to a lower side of the barrier hole 13a to cover a left (one) side of the barrier hole 13a. In this case, the flow path space S1 and the cycle space S2 may not communicate with each other.

The guide rail 16 may be installed in or at the one side of the partition wall 13, and may be coupled for the damper 15 to be movable. For example, the guide rail 16 may be installed in or at the left side surface of the partition wall 13 to guide movement of the damper 15 in the vertical direction UD.

A motor 15a may be electrically connected to the controller C, and may be operated according to a control signal from the controller C. The motor 15a provides power to the damper 15 to move the damper 15 on the guide rail 16 in the vertical direction UD. In this case, the motor 15a may be installed in the cycle part 12.

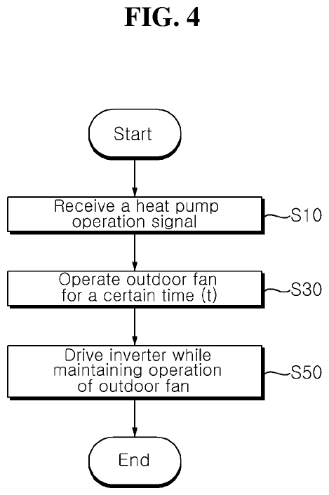

Referring to FIGS. 2 and 4, when an operation signal is received by the heat pump (S10), the controller C may operate the outdoor fan 6a for a certain or predetermined period of time t (S30). The operation signal may be a heating operation signal or cooling operation signal of the above-described heat pump. In this case, even if there is refrigerant which has leaked from the refrigerant pipe P installed in the cycle part 12 and remains in the cycle part 12, the remaining refrigerant may be discharged to the outside together with outdoor air by the flow of air, which flows from the hole 10a to the discharge hole through the barrier hole 13a, generated by the outdoor fan 6a at S30.

After S30, the controller C may control the operation of the compressor 2 by driving the inverter board while maintaining the operation of the outdoor fan 6a (S50). In this case, prior to driving an electric device component of the cycle part 12, such as an inverter board, which can cause sparks, the refrigerant, which is leaked to the cycle part 12 at S30 and may potentially remain, is discharged to the outside, thereby preventing a safety risk, such as fire, due to ignition of the flammable refrigerant caused by sparks of the inverter board.

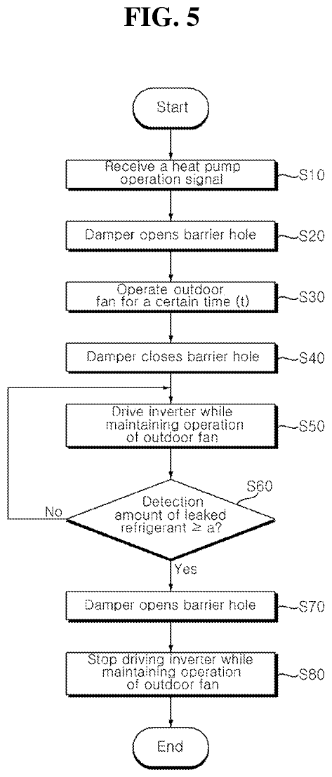

Referring to FIGS. 3 and 5, when an operation signal is received by the heat pump (S10), the controller C may control a position of the damper 15 so that the damper 15 opens the barrier hole 13a (S20). The operation signal may be a heating operation signal or a cooling operation signal of the above-described heat pump. In addition, the fact that the damper 15 opens the barrier hole 13a means that the damper 15 is located above the barrier hole 13a such that the flow path space S1 and the cycle space S2 communicate with each other through the barrier hole 13a (see FIG. 3A).

After S20, the controller C may operate the outdoor fan 6a for a certain or predetermined period of time t (S30). In this case, even if there is refrigerant which has leaked from the refrigerant pipe P installed in the cycle part 12 and remains in the cycle part 12, the remaining refrigerant may be discharged to the outside together with outdoor air by the flow of air, which flows from the hole 10a to the discharge hole through the barrier hole 13a, generated by the outdoor fan 6a at S30.

After S30, the controller C may control the position of the damper 15 so that the damper 15 closes the barrier hole 13a (S40). The fact that the damper 15 closes the barrier hole 13a means that the damper 15 is moved from the upper side of the barrier hole 13a toward the lower side to cover one side of the barrier hole 13a, so that the flow path space S1 and the cycle space S2 do not communicate with each other (see FIG. 3B).

After S40, the controller C may control the operation of the compressor 2 by driving the inverter board while maintaining the operation of the outdoor fan 6a (S50). In this case, prior to driving an electric device component of the cycle part 12, such as an inverter board, which can cause sparks, the refrigerant, which is leaked to the cycle part 12 at S30 and may potentially remain, is discharged to the outside, thereby preventing a safety risk, such as fire, due to ignition of the flammable refrigerant caused by sparks of the inverter board. In addition, as the damper 15 closes the barrier hole 13a at S40, the flow of air generated by the outdoor fan 6a at S50 may be formed only between the inflow hole and the discharge hole required for heat exchange between the refrigerant and outdoor air in the outdoor heat exchanger 6. Accordingly, the case in which S40 is performed prior to S50 may be advantageous in reducing power consumption of the outdoor fan in comparison with the case in which S40 is not performed prior to S50.

After S50, the controller C may determine whether a detection amount of the refrigerant leaked to the cycle part 12 is equal to or greater than a reference value a (S60). The outdoor unit 1a may be provided with a sensor 17 provided in the cycle part 12 to detect the refrigerant leaked to the cycle part 12. For example, the sensor 17 may be a gas detection sensor.

If it is determined that the detection amount of the refrigerant leaked to the cycle part 12 is greater than or equal to the reference value a at S60, the controller C may control the position of the damper 15 so that the damper 15 opens the barrier hole 13a (S70). Further, the controller C may stop driving of the inverter board while maintaining the operation of the outdoor fan 6a (S80). Furthermore, S70 and S80 may be performed simultaneously, or one may precede the other.

Accordingly, when it is detected that the refrigerant has leaked to the cycle part 12 more than the reference value a during the operation of the heat pump 1, the leaked refrigerant is discharged to the outside by the flow of air, which flows from the hole 10a to the discharge hole through the barrier hole 13a, generated by the outdoor fan 6a, and the drive of the inverter is stopped, thereby preventing a risk, such as fire, due to ignition of leaked refrigerant.

If it is determined that the detection amount of the refrigerant leaked to the cycle part 12 at S60 is less than the reference value a, the process may return to S50.

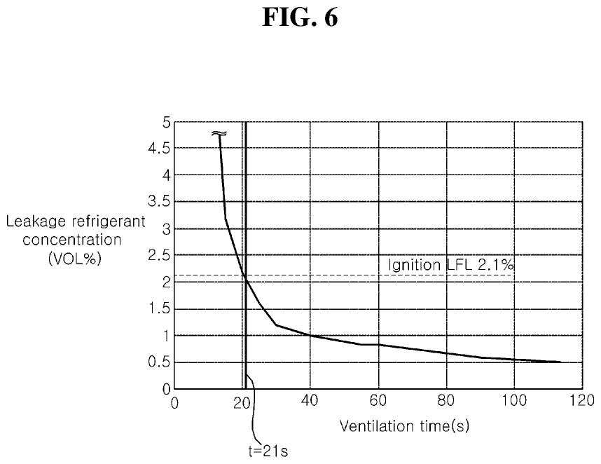

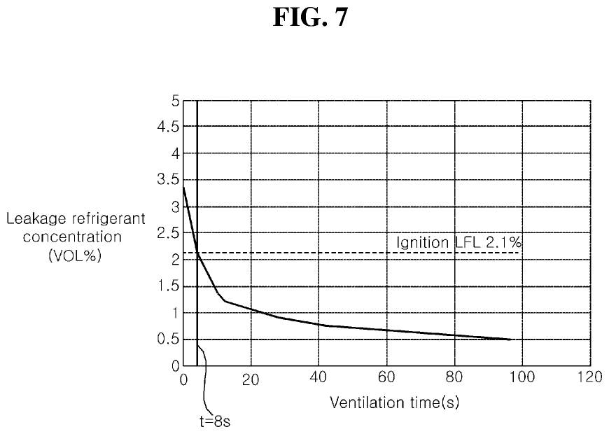

Referring to FIGS. 6 and 7, the time t during which the outdoor fan 6a operates at S30 (see FIGS. 4 and 5) may be calculated from a lower flammable limit (LFL) of the refrigerant, a molecular weight M of the refrigerant, a total amount of refrigerant (mR) circulating in the refrigerant pipe P, a ventilation air volume Vdot, and a volume V of the cycle part 12, for example. The ventilation air volume may be defined as an amount of air, generated by the outdoor fan 6a, flowing from the hole 10a to the discharge hole through the barrier hole 13a.

More specifically, the time t during which the outdoor fan 6a operates may be calculated based on Equation 1 below.

$$τ > \frac{- ln ( LFL )}{M ( 1.18 V - 0.65 mR ) - Vdot} \qquad [ Equation 1 ]$$

Referring to FIG. 6, for example, when the refrigerant circulating in the refrigerant pipe P is R290 and a total amount of refrigerant mR is 840 g, a change in a leakage refrigerant concentration VOL % according to a ventilation time s may be checked. The ventilation time s may refer to a time during which the outdoor fan 6a is operated to discharge the refrigerant leaked to the cycle part 12 to the outside. In addition, the leakage refrigerant concentration VOL % may be a value obtained by dividing a volume of refrigerant leaked to the cycle part 12 by an air volume of the cycle part 12. The volume of the refrigerant leaked to the cycle part 12 may be calculated based on information obtained from the sensor that detects the refrigerant leaked to the cycle part 12.

As the ventilation time s increases, it can be seen that the leakage refrigerant concentration VOL % decreases. In addition, the R290 refrigerant may be ignited when the leakage refrigerant concentration VOL % is 2.1% or more. In other words, the ignition LFL of the R290 refrigerant may be 2.1%. In this case, in order to prevent a risk, such as fire, due to ignition of the leaked refrigerant, the ventilation time s may be 21 seconds or more so that the leaked refrigerant concentration VOL % becomes less than or equal to the ignition LFL of the R290 refrigerant. That is, the time t during which the outdoor fan 6a is operated at S30 may be 21 seconds or more.

As another example with reference to FIG. 7, when the refrigerant circulating in the refrigerant pipe P is R290 and a total amount of refrigerant mR is 670 g, a change in a leakage refrigerant concentration VOL % according to a ventilation time s may be checked. The ventilation time s may refer to a time during which the outdoor fan 6a is operated to discharge the refrigerant leaked to the cycle part 12 to the outside. In addition, the leakage refrigerant concentration VOL % may be a value obtained by dividing a volume of refrigerant leaked to the cycle part 12 by an air volume of the cycle part 12. The volume of the refrigerant leaked to the cycle part 12 may be calculated based on information obtained from the sensor that detects the refrigerant leaked to the cycle part 12.

As the ventilation time s increases, it can be seen that the leakage refrigerant concentration VOL % decreases. In addition, the R290 refrigerant may be ignited when the leakage refrigerant concentration VOL % is 2.1% or more. In other words, the ignition LFL of the R290 refrigerant may be 2.1%. In this case, in order to prevent a risk, such as fire, due to ignition of the leaked refrigerant, the ventilation time s may be 8 seconds or more so that the leaked refrigerant concentration VOL % is less than or equal to the ignition LFL of the R290 refrigerant. That is, the time t during which the outdoor fan 6a is operated at S30 described above may be 8 seconds or more. Accordingly, as the total amount of refrigerant circulating through the refrigerant pipe P increases, the time t during which the outdoor fan 6a is operated at S30 described above may be increased.

According to embodiments disclosed herein, a heat pump is provided that may include an indoor unit including an indoor heat exchanger; an outdoor unit including an outdoor heat exchanger and a compressor that compresses a refrigerant; a housing that forms an outer shape of the outdoor unit and provides an internal space in which the outdoor heat exchanger and the compressor may be disposed; a partition wall that is disposed in the internal space of the housing, and divides the internal space into a flow path space in which the outdoor heat exchanger may be disposed and a cycle space in which the compressor may be disposed; an outdoor fan disposed in the flow path space to cause an air flow; and a controller that controls an operation of the compressor and the outdoor fan. The housing may include a hole that communicates with the cycle space, and the partition wall may include a barrier hole that communicates with the flow path space and the cycle space.

The housing may further include an inflow hole through which outdoor air is provided to the outdoor fan, and a discharge hole through which the air that passes through the outdoor fan is discharged. The inflow hole and the discharge hole may be formed in a portion of the housing that defines a boundary of the flow path space.

The partition wall may extend lengthwise in a vertical direction. The flow path space and the cycle space may be disposed in or at left and right (lateral) sides with the partition wall interposed therebetween. The barrier hole may be provided adjacent to a lower end of the partition wall. The hole may be formed in a portion of the housing that defines a boundary of the cycle space and positioned above the barrier hole.

The controller may operate the outdoor fan for a certain or predetermined period of time, prior to driving the compressor, when a heat pump operation signal is input.

The heat pump may further include a damper which may be coupled to one side of the partition so as to be movable in a vertical direction, and a guide rail that guides movement of the damper. The damper may be positioned above the barrier hole to open the barrier hole, or covers one side of the barrier hole to close the barrier hole.

The controller may open the barrier hole by the damper and operate the outdoor fan for a certain or predetermined period of time, prior to driving the compressor, when the heat pump operation signal is input. The controller may close the barrier hole by the damper, after the outdoor fan is operated for a certain or predetermined period of time.

The heat pump may further include a sensor that detects refrigerant leaked to the cycle space. The controller may open the barrier hole by the damper while operating the outdoor fan and stop driving of the compressor, when it is determined that the refrigerant leaked to the cycle space is greater than or equal to a reference amount, based on information obtained from the sensor. The certain time may be increased as a total amount of refrigerant circulating the outdoor unit is increased.

The heat pump may further include an inverter board which may be installed in the cycle space to control a frequency of the compressor. The controller may operate the outdoor fan for a certain or predetermined period of time, prior to driving the inverter board, when a heat pump operation signal is input.

Embodiments disclosed herein provide a heat pump capable of discharging leaked refrigerant to the outside using an outdoor fan without having a separate ventilation fan, even if the refrigerant leaks to a cycle part where a compressor, and an inverter board, for example, are installed. Embodiments disclosed herein further provide a heat pump capable of discharging a refrigerant that may potentially remain in a cycle part to the outside by operating an outdoor fan for a certain or predetermined period of time, prior to driving an electric device component of the cycle part, such as an inverter board, that can cause sparks. Embodiments disclosed herein furthermore provide a heat pump capable of reducing power consumption of an outdoor fan by adjusting a position of a damper so that a flow path part at which an outdoor heat exchanger is installed and a cycle part do not communicate with each other, when a ventilation operation of discharging the refrigerant leaked to the cycle part to the outside is completed.

Embodiments disclosed herein have been made in view of the above problems, and provide a heat pump capable of discharging a leaked refrigerant to the outside using an outdoor fan without having a separate ventilation fan, even if the refrigerant leaks to a cycle part where a compressor, and an inverter board, for example, are installed. Embodiments disclosed herein further provide a heat pump capable of discharging a refrigerant that may potentially remain in a cycle part to the outside by operating an outdoor fan for a certain or predetermined period of time, prior to driving an electric device component of the cycle part, such as an inverter board, that can cause sparks. Embodiments disclosed herein furthermore provide a heat pump capable of reducing power consumption of an outdoor fan by adjusting a position of a damper so that a flow path part where an outdoor heat exchanger is installed and a cycle part do not communicate with each other, when a ventilation operation of discharging the refrigerant leaked to the cycle part to the outside is completed.

Embodiments disclosed herein provide a heat pump that may include an indoor unit including an indoor heat exchanger; an outdoor unit including an outdoor heat exchanger and a compressor that compresses a refrigerant; a housing that forms an outer shape of the outdoor unit and provides an internal space in which the outdoor heat exchanger and the compressor may be disposed; a partition wall that is disposed in the internal space of the housing, and divides the internal space into a flow path space in which the outdoor heat exchanger may be disposed and a cycle space in which the compressor may be disposed; an outdoor fan that is disposed in the flow path space to cause an air flow; and a controller that controls an operation of the compressor and the outdoor fan. The housing may include a hole that communicates with the cycle space, and the partition wall may include a barrier hole that communicates with the flow path space and the cycle space.

Additional scope of applicability will become apparent from description. However, various changes and modifications within the spirit and scope may be clearly understood by those skilled in the art, and thus, description and specific embodiments should be understood as being given by way of example only.

Certain or other embodiments described are not mutually exclusive or distinct from each other. Certain or other embodiments described may have configurations or functions used in combination or jointly. For example, it means that a configuration A described in a specific embodiment and/or drawing may be combined with a configuration B described in another embodiment and/or drawing. That is, even if the combination of configurations is not directly described, the combination is possible except for the case where the combination is described to be impossible. The above description should not be construed as restrictive in all respects and should be considered as illustrative. The scope should be determined by rational interpretation of the appended claims, and all changes within the equivalent scope are included in the scope.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A heat pump, comprising:
an indoor unit including an indoor heat exchanger;
an outdoor unit including an outdoor heat exchanger and a compressor that compresses a refrigerant;
a housing that forms an outer shape of the outdoor unit and provides an internal space in which the outdoor heat exchanger and the compressor are disposed;
a partition wall that is disposed in the internal space of the housing and divides the internal space into a flow path space in which the outdoor heat exchanger is disposed and a cycle space in which the compressor is disposed;
an outdoor fan disposed in the flow path space to cause an air flow; and
a controller that controls an operation of the compressor and the outdoor fan, wherein the housing includes a hole that communicates with the cycle space, and the partition wall includes a barrier hole that communicates with the flow path space and the cycle space.

2. The heat pump of claim 1, wherein the housing further comprises:
an inflow hole through which outdoor air flows to the outdoor fan; and
a discharge hole through which the air that has passed through the outdoor fan is discharged, wherein the inflow hole and the discharge hole are formed in a portion of the housing that defines a boundary of the flow path space.

3. The heat pump of claim 2, wherein the controller operates the outdoor fan for a predetermined period of time, prior to driving the compressor, when a heat pump operation signal is input.

4. The heat pump of claim 2, wherein the partition wall extends lengthwise in a vertical direction, wherein the flow path space and the cycle space are disposed at lateral sides of the partition wall with the partition wall interposed therebetween, and wherein the barrier hole is provided adjacent to a lower end of the partition wall.

5. The heat pump of claim 4, wherein the hole is formed in a portion of the housing that defines a boundary of the cycle space and positioned above the barrier hole.

6. The heat pump of claim 4, further comprising:
a damper that is coupled to one side of the partition so as to be movable in a vertical direction; and
a guide rail that guides movement of the damper, wherein the damper is positioned above the barrier hole to open the barrier hole, or covers one side of the barrier hole to close the barrier hole.

7. The heat pump of claim 6, wherein the controller opens the barrier hole by the damper and operates the outdoor fan for the predetermined period of time, prior to driving the compressor, when a heat pump operation signal is input.

8. The heat pump of claim 7, wherein the controller closes the barrier hole by the damper, after the outdoor fan is operated for the predetermined period of time.

9. The heat pump of claim 8, further comprising a sensor that detects that the refrigerant has leaked to the cycle space, wherein the controller opens the barrier hole by the damper while operating the outdoor fan and stops driving of the compressor, when it is determined that an amount of the refrigerant which has leaked to the cycle space is greater than or equal to a reference amount, based on information obtained from the sensor.

10. The heat pump of claim 7, wherein the predetermined period of time is increased as a total amount of refrigerant circulating in the outdoor unit is increased.

11. The heat pump of claim 1, further comprising an inverter board installed in the cycle space to control a frequency of the compressor, wherein the controller operates the outdoor fan for a predetermined period of time, prior to driving the inverter board, when a heat pump operation signal is input.

12. An outdoor unit for a heat pump, the outdoor unit comprising:
an outdoor heat exchanger and a compressor that compresses a refrigerant;
a housing that forms an outer shape of the outdoor unit and provides an internal space in which the outdoor heat exchanger and the compressor are disposed;
a partition wall that is disposed in the internal space of the housing, and divides the internal space into a flow path space in which the outdoor heat exchanger is disposed and a cycle space in which the compressor is disposed;
an outdoor fan that is disposed in the flow path space to cause an air flow; and
a controller that controls an operation of the compressor and the outdoor fan, wherein the housing includes a hole that communicates with the cycle space, and the partition wall includes a barrier hole that communicates with the flow path space and the cycle space.

13. The outdoor unit of claim 12, wherein the housing further comprises:
an inflow hole through which outdoor air flows to the outdoor fan; and
a discharge hole through which the air that has passed through the outdoor fan is discharged, wherein the inflow hole and the discharge hole are formed in a portion of the housing that defines a boundary of the flow path space.

14. The outdoor unit of claim 13, wherein the controller operates the outdoor fan for a predetermined period of time, prior to driving the compressor, when an operation signal is input.

15. The outdoor unit of claim 13, wherein the partition wall extends lengthwise in a vertical direction, wherein the flow path space and the cycle space are disposed at lateral sides of the partition wall with the partition wall interposed therebetween, and wherein the barrier hole is provided adjacent to a lower end of the partition wall.

16. The outdoor unit of claim 15, wherein the hole is formed in a portion of the housing that defines a boundary of the cycle space and positioned above the barrier hole.

17. The outdoor unit of claim 14, further comprising:
a damper that is coupled to one side of the partition so as to be movable in a vertical direction; and
a guide rail that guides movement of the damper, wherein the damper is positioned above the barrier hole to open the barrier hole, or covers one side of the barrier hole to close the barrier hole.

18. The outdoor unit of claim 17, wherein the controller opens the barrier hole by the damper and operates the outdoor fan for the predetermined period of time, prior to driving the compressor, when an operation signal is input, and wherein the controller closes the barrier hole by the damper, after the outdoor fan is operated for the predetermined period of time.

19. The outdoor unit of claim 12, further comprising an inverter board installed in the cycle space to control a frequency of the compressor, wherein the controller operates the outdoor fan for a predetermined period of time, prior to driving the inverter board, when an operation signal is input.

20. A heat pump, comprising:
an indoor unit including an indoor heat exchanger;
an outdoor unit, including:
an outdoor heat exchanger;
a compressor that compresses a refrigerant;
a housing that forms an outer shape of the outdoor unit;
a partition wall that is disposed in the housing and divides the housing into a flow path space in which the outdoor heat exchanger is disposed and a cycle space in which the compressor is disposed;
an outdoor fan disposed in the flow path space to cause an air flow;
a controller that controls an operation of the heat pump, wherein the housing includes a hole that communicates with the cycle space, and the partition wall includes a barrier hole that communicates with the flow path space and the cycle space; and
an inverter board installed in the cycle space to control a frequency of the compressor, wherein the controller operates the outdoor fan for a predetermined period of time, prior to driving the inverter board, when a heat pump operation signal is input.
